(19) United States
(12) Patent Application Publication
(10) Pub. No.: US 2012/0087130 A1
(43) Pub. Date: Apr. 12, 2012

(54) ALTERNATING CURRENT LED ILLUMINATION APPARATUS

(75) Inventors: SHENG-HSIANG KUNG, Chu-Nan (TW); CHIH-MING LAI, Chu-Nan (TW)

(73) Assignee: FOXSEMICON INTEGRATED TECHNOLOGY, INC., Chu-Nan (TW)

(21) Appl. No.: 13/300,627

(22) Filed: Nov. 20, 2011

Related U.S. Application Data
(66) Substitute for application No. 12/901,560, filed on Oct. 10, 2010, now abandoned.

(51) Int. Cl. F21S 4/00

(52) U.S. Cl. 362/249.02

(57) ABSTRACT

An alternating current LED illumination apparatus includes a heat dissipation plate, a plurality of LED chips arranged on the heat dissipation plate, a circuit layer, an encapsulation, two electrodes located on the heat dissipation plate and exposed out of the encapsulation, and a driving element. The LED chips are thermally connected with the heat dissipation plate, and at least two of the LED chips are connected in anti-parallel. The encapsulation covers the LED chips and at least part of the circuit layer. The driving element comprises a transformer and a switch. The transformer has an input terminal and an output terminal, the input terminal is configured to connect to an alternating current (AC) power source, and the output terminal is electrically connected with the electrodes by the switch.

### BACKGROUND

1. Technical Field

The disclosure relates to LED illumination apparatuses, and particularly to an alternating current LED illumination apparatus.

2. Description of the Related Art

LEDs' many advantages, such as high luminosity, low operational voltage, low power consumption, compatibility with integrated circuits, easy driving, long term reliability, and environmental friendliness have promoted their wide use as a light source. Now, LEDs are commonly applied in environmental lighting.

The luminous intensity of LED is in direct proportion to the injection current. Thus, LED is commonly driven by direct current. However, the luminous efficiency decreases with increasing injection current. The junction temperature of LED increases with the injection current increasing. It is well known that the lifetime of the LED will decrease with the junction temperature of LED increasing. In order to decrease the temperature of LED during the operating period, Pulse Width Modulation Dimming (PWM Dimming) can be used to control the LED. However, the PWM operates with constant current. Thus, the driving circuit of LED has to include at least one AC (alternating current) to DC (direct current) converter, decreasing utilization efficiency of the LED illumination apparatus and increasing costs.

Therefore, it is desirable to provide an alternating current LED illumination apparatus which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present alternating current LED illumination apparatus. Moreover, in the drawings, like reference numerals designate corresponding parts throughout the views.

FIG. 1 is a schematic view of an alternating current LED illumination apparatus in accordance with a first embodiment.

FIG. 2 is a schematic view of circuit of the alternating current LED illumination apparatus of FIG. 1.

FIG. 3 is a schematic view of circuit of an alternating current LED illumination apparatus in accordance with a second embodiment.

### DETAILED DESCRIPTION

Embodiments of an alternating current LED illumination apparatus as disclosed are described in detail here with reference to the drawings.

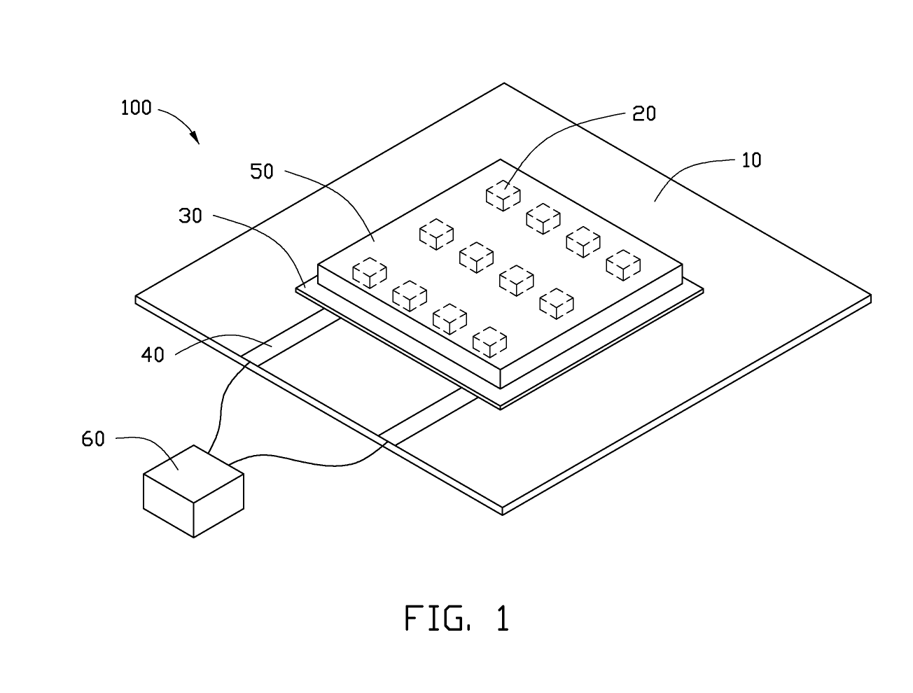

Referring to FIG. 1, an alternating current LED illumination apparatus 100 includes a heat dissipating plate 10, a plurality of LED chips 20, a circuit layer 30, two electrodes 40, an encapsulation 50, and a driving element 60.

The heat dissipating plate 10 can be high thermal conductive and electrically insulating material, such as Si₃N₄, SiC, ZrO₂, B₄C, TiB₂, AlₓO_{y}, AlN, BeO, or a combination thereof. Moreover, the heat dissipating plate 10 can be an electrical conductive substrate coated with electrically insulating material.

The plurality of LED chips 20 is mounted on one surface of the heat dissipating plate 10 and thermally connecting to the heat dissipating plate 10. The distance between adjacent LED chips 20 exceeds 500 μm, preferably, not less than 900 μm. The length of the LED chips 20 should not exceed 350 μm. Preferably, the length of the LED chips 20 should not exceed 150 μm. The LED chips 20 can be yellow light LED, blue light LED, or UV LED.

The circuit layer 30 can be deposited on the heat dissipating plate 10 by chemical vapor deposition or sputtering. The positive and negative electrodes (not shown) of each LED chip 20 electrically connect to the circuit layer 30.

The electrodes 40 are mounted on the heat dissipating substrate 10. In this embodiment, the electrodes 40 are mounted on the surface of the heat dissipating substrate 10 having the LED chips 20. The electrodes 40 electrically connect to the circuit layer 30.

The encapsulation layer 50 covering the plurality of LED chips 20 and a part of the circuit layer 30 is mounted on the heat dissipating substrate 10. The electrodes 40 are exposed beyond the encapsulation layer 50. The encapsulation 50 can be silicone, epoxy resin, PMMA, or plastic. The encapsulation 50 can be doped with at least one fluorescent material, such as sulfides, aluminates, oxides, silicates, or nitrides. The commonly used fluorescent materials are YAG (yttrium aluminum garnet) and TAG (terbium aluminum garnet).

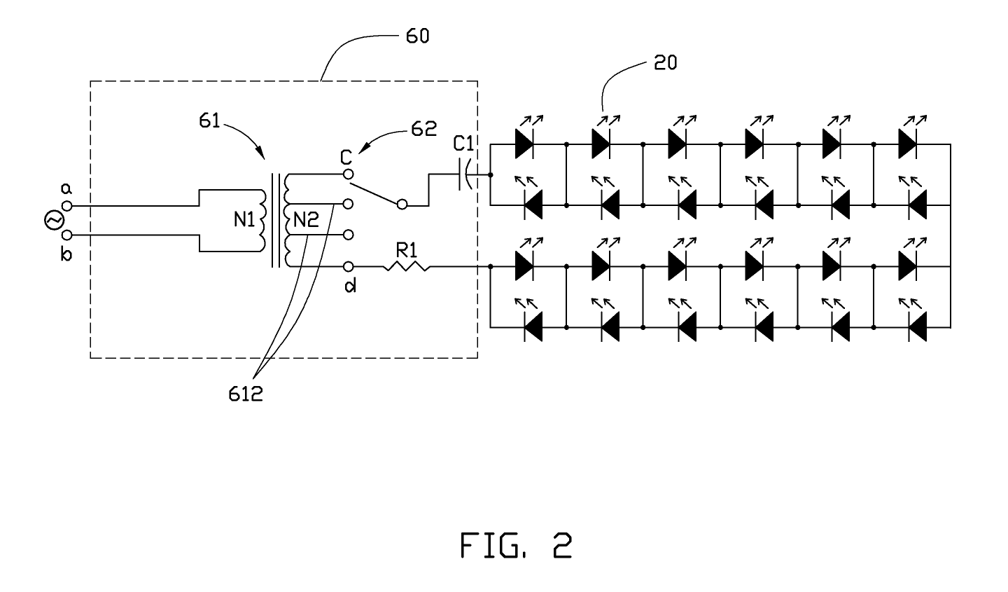

Referring to FIG. 2, the driving element 60 includes a transformer 61 and a switch 62. The transformer 61 has a primary coil N1 and a secondary coil N2. The two ends a, b of the primary coil N1 are the input terminal of the transformer 61 and connect to an AC power source. The voltage of the AC power source is usually 100V-230V. Between the two ends c, d of the secondary coil N2 have a plurality of tappings 612. The two ends c, d of the secondary coil N2 and the tappings 612 form the output terminal of the transformer 61. One end of the switch 62 selectively connects to any one of the tapping 612 or end c of the secondary coil N2. The other end of the switch 62 connects to a capacitor C1. The end d of the secondary coil N2 connects to a resistor R1. The unoccupied end of the capacitor C1 and the resistor R1 connect to the electrodes 40 of the heat dissipating plate 10 as output terminal of the driving element 60 and provide driving voltage to the plurality of LED chips 20.

An end of the switch 62 connecting selectivity to the end c or one of the tapping 612 of the secondary coil N2 changes the output driving voltage to provide power to different numbers of LED chips 20. When the output voltage increases, more LED chips 20 can be turned on or the brightness of the LED chips 20 enhanced. The nearer the coil numbers of the tapping 612 of the secondary coil N2 is, the more tendered dimming effect is.

The plurality of LED chips 20 is connected first anti-parallel to every two chips and then in series in this embodiment. In other words, the LED chips 20 are divided into a plurality of pairs. Twelve pairs are shown in FIG. 2. The two LED chips of each pair are connected anti-parallel. The twelve pairs are connected in series with each other. The two ends of the plurality of LED chips 20 connected in series connect to the electrodes 40 of the heat dissipating substrate 10.

The driving element 60 of the alternating LED illumination apparatus 100 connects directly to the AC power to drive the plurality of LED chips 20. The driving element 60 is simpler than the common driving circuit. Furthermore, the alternating LED illumination apparatus 100 requires no AC-DC converters, and power utilization efficiency of the alternating LED illumination apparatus 100 is increased.

Moreover, the switch 62 of the driving element 60 selectively connects to the output terminal of the transformer 61. Thus, the driving element 60 outputs different driving voltage to the plurality of LED chips 20. According to needs, that can adjust the luminous intensity of the plurality of LED chips 20.

The operating current is not greater than 50 mA. Preferably, the operating current is not greater than 30 mA.

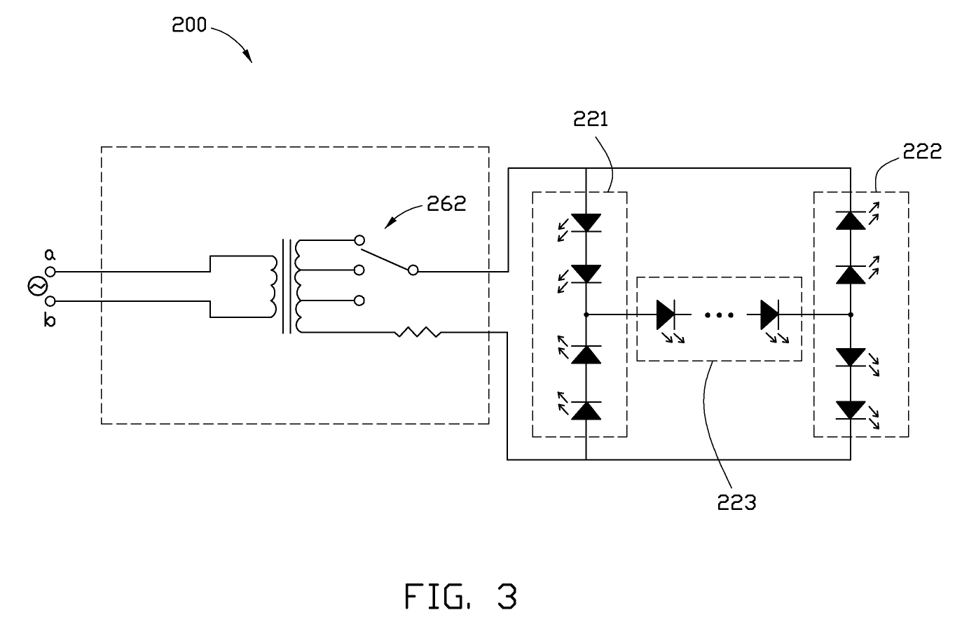

Referring to FIG. 3, a second embodiment of an alternating LED illumination apparatus 200 differs from alternating LED illumination apparatus 100 only in that the alternating LED illumination apparatus 200 further includes a first group of LED chips 221, a second group of LED chips 222, and a third group of LED chips 223, all connected in series. The first group of LED chips 221 and the second group of LED chips 222 connect in parallel. One end of the third group of LED chips 223 connects to the center node of the first group of LED chips 221. The other end of the third group of LED chips 223 connects to the center node of the second group of LED chips 222. The first group of LED chips 221 and the second group of LED chips 222 respectively include LED chips of even number not less than two. The third group of LED chips 223 includes LED chips not less than two. One end of the switch 262 directly connects to a sharing node of the first group of LED chips 221 and the second group of LED chips 222.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An alternating current LED illumination apparatus, comprising:
a heat dissipating plate;
a plurality of LED chips arranged on and thermally connected to the heat dissipating plate, at least two of the LED chips connected in anti-parallel;
a circuit layer arranged on the heat dissipating plate and electrically connected to the plurality of LED chips;
an encapsulation covering the plurality of LED chips and a part of the circuit layer;
two electrodes mounted on the heat dissipating plate and exposed out of the encapsulation; and
a driving element including a transformer and a switch, wherein the transformer has an input terminal and an output terminal, the input terminal is configured to connecting to an alternating current (AC) power source, the output terminal is electrically connected with the electrodes of the heat dissipating plate by the switch, and the switch is selectively connectable to different points of the output terminal of the transformer, so that the driving element can output a selected one of different driving voltages to the LED chips.

2. The alternating current LED illumination apparatus of claim 1, wherein the distance between adjacent LED chips is not less than 500 μm.

3. The alternating current LED illumination apparatus of claim 1, wherein the length of each of the LED chips does not exceed 350 μm.

4. The alternating current LED illumination apparatus of claim 1, wherein the thickness of each of the LED chips does not exceed 200 μm.

5. The alternating current LED illumination apparatus of claim 1, wherein one end of the switch connecting to the LED chips connects to a capacitor in series.

6. The alternating current LED illumination apparatus of claim 5, wherein another end of the switch connecting to the LED chips further connects to a resistor in series.

7. The alternating current LED illumination apparatus of claim 1, wherein the plurality of LED chips connects first with every two chips in anti-parallel and then connects in series, and the two ends of the LED chips electrically connect to the electrodes on the heat dissipating plate.

8. The alternating current LED illumination apparatus of claim 1, wherein the plurality of LED chips includes a first group of LED chips, a second group of LED chips, and a third group of LED chips, all chips in the group are connected in series; the first group of LED chips and the second group of LED chips connect in parallel; one end of the third group of LED chips connects to the center node of the first group of LED chips; and the other end of the third group of LED chips connects to the center node of the second group of LED chips.

9. The alternating current LED illumination apparatus of claim 8, wherein the first group of LED chips and the second group of LED chips respectively include LED chips of even number not less than two, and the third group of LED chips includes not less than two LED chips.
